(19) United States
(12) Patent Application Publication
(10) Pub. No.: US 2016/0203558 A1
(43) Pub. Date: Jul. 14, 2016

(54) SYSTEM AND METHOD FOR COMPARING RETIREMENT PLAN SERVICES

(71) Applicants: Claiborne B. Morton, III, Miramar Beach, FL (US); Shefali Agrawal, Fremont, CA (US)

(72) Inventors: Claiborne B. Morton, III, Miramar Beach, FL (US); Shefali Agrawal, Fremont, CA (US)

(21) Appl. No.: 14/966,855

(22) Filed: Dec. 11, 2015

Related U.S. Application Data
(60) Provisional application No. 62/102,635, filed on Jan. 13, 2015.

(51) Int. Cl. G06Q 40/06; G06Q 10/10

(52) U.S. Cl. CPC G06Q 40/06; G06Q 10/1057

(57) ABSTRACT

Online market place where employers can obtain quotes for retirement plan services from multiple providers enabling employers to compare complex plan costs and select the appropriate service providers for their retirement plan. This invention creates an online marketplace for the retirement plan industry that enables an employer to comparison shop and setup the most cost effective plan, thereby having a positive effect on investment returns on behalf of retirement savings of plan participants. This invention enables an employer to get quotes from multiple service providers and presented on a user interface screen which enables an employer to compare quotes

### CROSS-REFERENCE TO RELATED APPLICATION

This application claims the benefit of priority of U.S. provisional application No. 62/102,635, filed Jan. 13, 2015, the contents of which are herein incorporated by reference.

### BACKGROUND OF THE INVENTION

The present invention relates to retirement plan services, and more particularly, to the offering of retirement plan services by a plan provider and the selection of a retirement plan service by an employer.

Fees, costs and investment selection for retirement plans can be complex. Retirement plan costs and investment options affect the growth of employee's retirement assets. The plan investment options need to be appropriate for the plan demographic and sufficient for proper portfolio construction. For an employer to comparison shop, get quotes from multiple providers, compare the fees and to ensure appropriate investment options, is an extremely complex operation.

No online marketplace exists for an employer to comparison shop for retirement plan services. Employers have to manually request a quote from each service provider, and then attempt to analyze it. Employers are not aware of the retirement service providers, and often turn to a costly non-specialist advisor for assistance. Establishing an appropriate retirement plan is an extremely time consuming and significant effort for an employer.

Utilizing present systems or costly non-specialist advisor driven distribution of retirement plans, it is virtually impossible for an employer to comparison shop, obtain quotes from multiple retirement plan providers, compare the fees and ensure appropriate selection of an investment option

No online marketplace exists for comparison shopping of retirement plan services from multiple service providers.

As can be seen, there is a need for an online marketplace for the retirement plan industry that enables an employer to comparison shop and setup the most cost effective plan, thereby having a positive effect on investment returns on savings of plan participants.

### SUMMARY OF THE INVENTION

In one aspect of the invention, there is disclosed a method of providing an on-line marketplace for retirement plans. The method may comprise automatically at a server of a retirement plan advisor, in response to a request for a quote, activated via a quote request page presented on a first web browser of an employer seeking a retirement plan, determining at least one appropriate retirement plan type corresponding to the request for the quote. The method may also include automatically retrieving, from a non-transitory computer storage media coupled to the server, information identifying at least one retirement plan provider offering the at least one appropriate retirement plan type in the marketplace. After determining the appropriate retirement plan, the method automatically transmits the request for the quote to the retirement plan provider. The method automatically, in response to receiving at least one quote submission, activated via a quote submission page presented on a second web browser of the retirement plan provider, transforms the at least one quote submission to a plan comparison data. The method, then automatically generates for the first web browser, a retirement plan comparison page presenting the plan comparison data set for each of the quote submissions to the employer.

The request for quote for the method may also comprise a number of participating employees. The request for quote may include an indication that the employer has an existing retirement plan. When the employer has an existing retirement plan, the method may prompt the employer to input information pertaining to the existing retirement plan via the first web browser. The information pertaining to the existing retirement plan may include the plan type and/ or an asset base, and may also include an identification of an existing retirement plan provider.

In other aspects of the invention, the method may also comprise determining whether the retirement plan provider is accepting requests for quotes; determining whether the request for quote is suitable for the provider

Another aspect of the invention is a non-transitory computer-readable memory adapted for use by a retirement plan advisor in serving web pages offering a marketplace for retirement plans, the non-transitory computer-readable memory used to direct a server of the retirement plan advisor to perform the steps of: a) automatically at a server of a retirement plan advisor, in response to a request for a quote, activated via a quote request page presented on a first web browser of an employer seeking a retirement plan, determining at least one appropriate retirement plan type corresponding to the request for the quote; b) automatically retrieving, from a non-transitory computer storage media coupled to the server, information identifying at least one retirement plan provider offering the at least one appropriate retirement plan type in the marketplace; c) automatically at the server, transmitting the request for the quote to the at least one retirement plan provider; d) automatically at the server, in response to receiving at least one quote submission, activated via a quote submission page presented on a second web browser of the retirement plan provider, transforming the at least one quote submission to a plan comparison data, and e) automatically with the server computer generating for the first web browser, a retirement plan comparison page presenting the plan comparison data set for each of the at least one quote submissions to the employer. The request for quote may a number of participating employees.

The computer-readable memory may also be used to direct the server of the retirement plan provider to perform the further step of may receiving, via the first web browser, an indication that the employer has an existing retirement plan. The memory may then prompt the employer to input information pertaining to the existing retirement plan via the first web browser. The information pertaining to the existing retirement plan may include the plan type. The information pertaining to the existing retirement plan may also include an asset base and may even include an identification of an existing retirement plan provider.

The computer-readable memory may also be used to direct the server of the retirement plan provider to perform the further step of determining whether the retirement plan provider is accepting requests for quotes: determining whether the request for quote is suitable for the provider.

In yet another aspect of the invention, a computerized system for a retirement plan advisor serving web pages offering a marketplace for retirement plans is also disclosed. The system comprises a) means, at a server of the retirement plan advisor, in response to a request for a quote, received from a first web activated by an employer seeking a retirement plan, to automatically determine at least one appropriate retirement plan type corresponding to the request for the quote, b) server means for automatically retrieving, from a non-transitory computer storage media coupled to the server, information identifying at least one retirement plan provider offering the at least one appropriate retirement plan type in the marketplace; c) server means for automatically transmitting the request for the quote to the at least one retirement plan provider; d) server means for automatically, in response to receiving at least one quote submission, activated via a quote submission page presented on a second web browser of the retirement plan provider, transforming the at least one quote submission to a plan comparison data; and e) server means for automatically computer generating for the first web browser, a retirement plan comparison page presenting the plan comparison data set for each of the at least one quote submissions to the employer.

These and other features, aspects and advantages of the present invention will become better understood with reference to the following drawings, description and claims.

### BRIEF DESCRIPTION OF THE DRAWINGS

FIG. 1 is a schematic of a system architecture for the market place for retirement plans.

FIG. 2 is a schematic diagram of the marketplace for retirement plans.

FIG. 3 is a flow chart of the marketplace process.

FIG. 4 is a flow chart of an intelligent quote request routing for the retirement plan marketplace.

FIG. 5 is an illustration of a user interface tool to help employers compare multiple quotes from providers.

FIG. 6 is an alternative embodiment of the user interface tool to help employers compare quotes from providers.

FIG. 7 is an illustration of a user interface tool to assist an employer with requesting a quote for a retirement plan.

FIG. 8 is an illustration of a user interface tool to assist an employer with an existing retirement plan to request a quote for a retirement plan in the marketplace.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system for obtaining retirement plan services comprising: a computer having a user interface; and a program product comprising machine-readable program code for causing, when executed, the computer to perform the following process steps: producing a virtual marketplace for retirement plan services; prompting an employer to input company and employee information; storing the information entered into a database; receiving a request for quotes from the employer; analyzing the data received from the employer; determining the at least one appropriate plan type; routing the quote request to a plurality of service providers; receiving at least one quote from at least one service provider along with documents for the quote; sending the at least one quote to an adviser; approving each quote; and comparing each quote and presenting each quote in an easy to understand format for the employer to review.

The present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

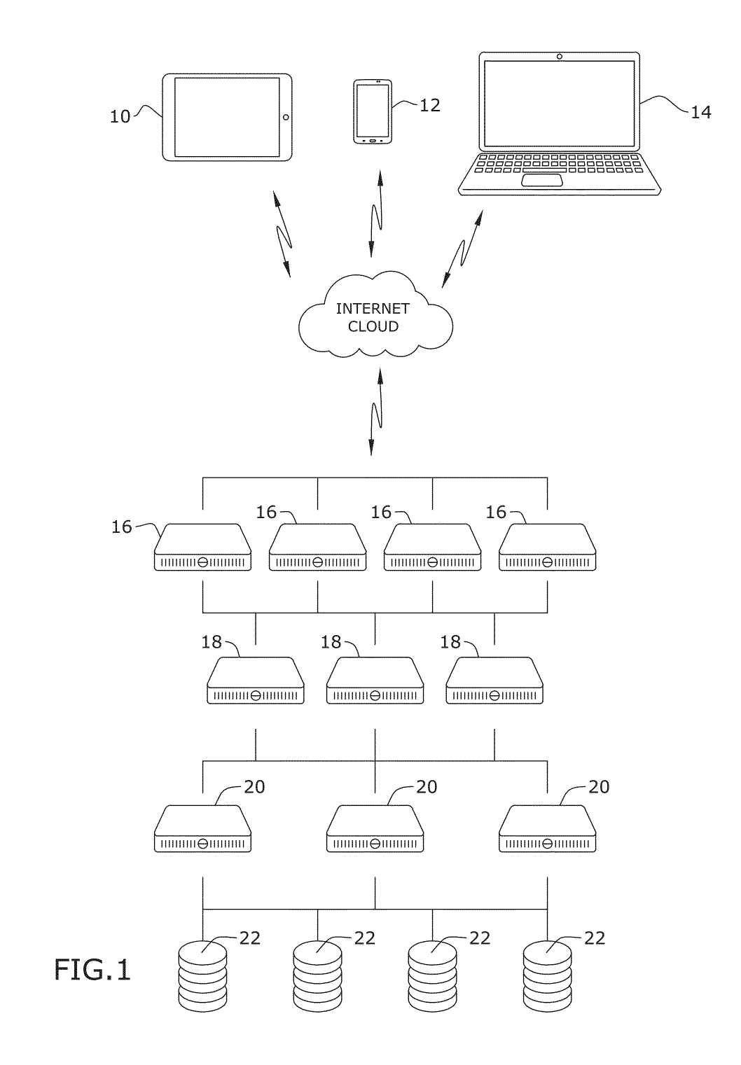

As seen in reference to FIG. 1, the system is accessible by one or more users operating one or more computing devices 10, 14, operatively connected to a computer network, such as the Internet via a network connection. The network connection may be provided via any suitable network connection, such as wireless or wired communications. The computing devices may include a tablet 10, a smartphone, and a desktop or laptop computer 14.

The system may be hosted on one or more application/business logic servers 18 operatively connected to a computer communications network, such as the internet. The system architecture may also include one or more load balancing servers 16 that are in communication with the application servers 18. The application servers 18 may also be operatively connected to one or more database servers 20, which provide access to one or more data stores, or warehouses 22. The logic servers 18, load balancing servers 16, database servers 20, and data stores 22, may be provided through a cloud based system, such as Microsoft Azure, Amazon web service AWS, or similar cloud based platform.

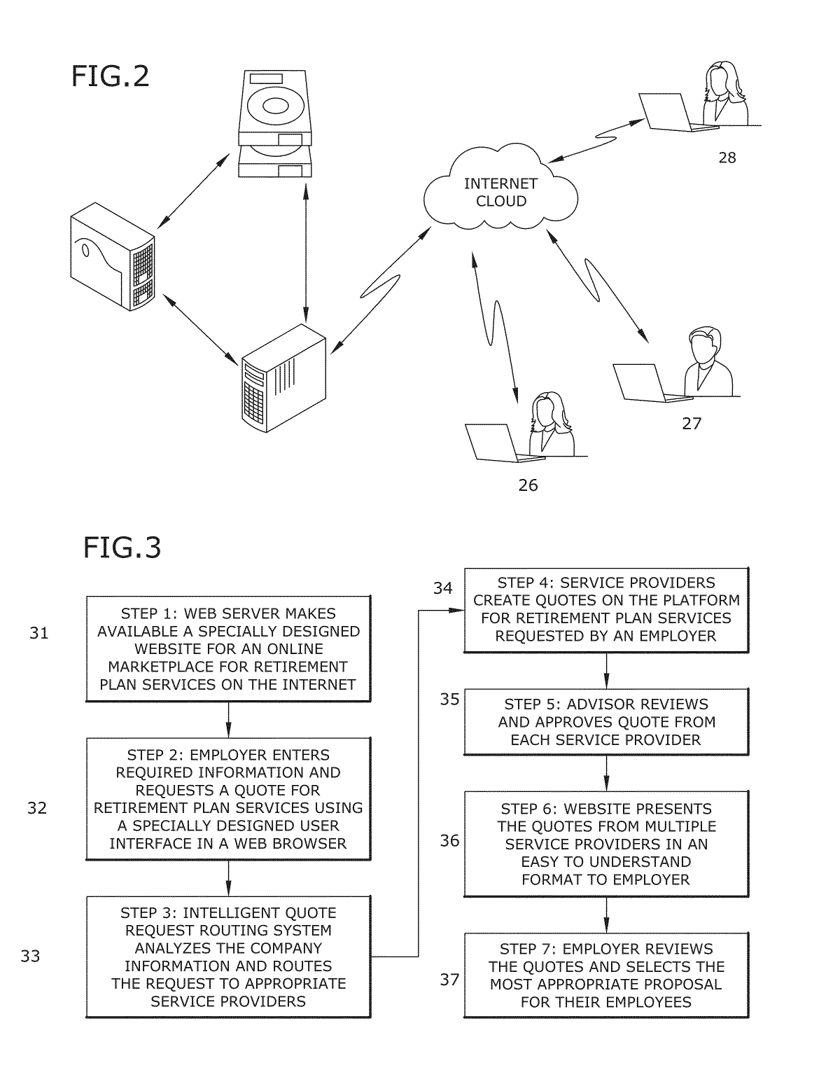

As shown in reference to FIG. 2, the marketplace for retirement services is accessible by a plurality of system users. System users may include an employer 26 who may be seeking retirement plan options for its employees. A user may also include a retirement plan representative, or provider 28 who may be interested in offering a retirement plan option and related services to the employer 26. The user may also include a retirement plan investment advisor 27, who may review the quotes for suitability and completeness before forwarding all the quotes to the employer. The role of the advisor is optional and the quotes could be forwarded to the employer without advisor intervention. The system and method of the present invention provides a marketplace for connecting these respective users.

An aspect of the online marketplace for retirement plan services according to the present invention is shown in reference to FIG. 3. As an initial step, at block 31 a market host provides a specially configured web server to facilitate the market for retirement plan services. The web server provides a website that is accessible to the respective market participants, such as the employer 26, an advisor 27, or a retirement plan representative or service provider 28. The user interface, which works in a web browser, may be implemented in any one of the various frameworks and programming languages available.

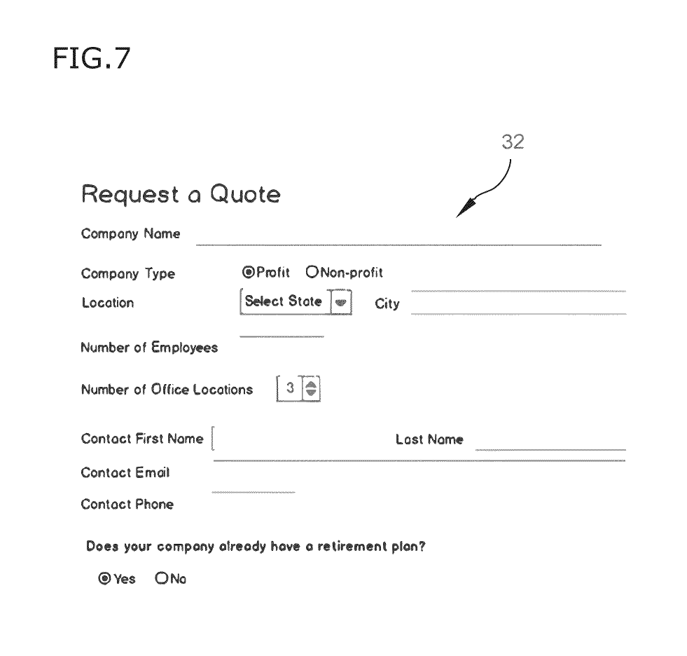

For an employer 26 seeking a retirement plan for its employees, the employer enters information into a quote request portal 32 in order to submit a request for a retirement plan quote. A representative quote request portal 32 is illustrated in reference to FIG. 7. The information may include demographic information pertaining to the business, such as its corporate name, corporate form, location of its corporate headquarters and states in which it has employees, number of employees that may be eligible to participate in the retirement plan.

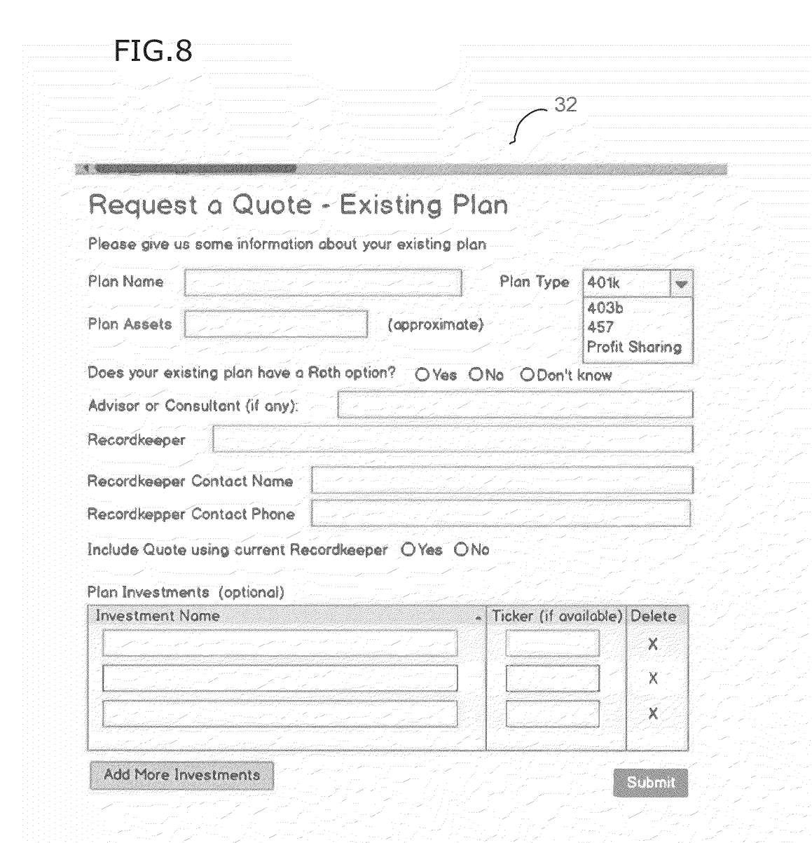

The information may also include a projected asset base for the employer's participating employees, which may be used by a retirement plan representative 28 to formulate retirement plan options and assess the potential value of the retirement plan to being requested. The company information may also include the number of locations the company may have, number of payrolls, type of plan requested, assets in existing plans if any, investment options in existing plans if any, as shown in reference to FIG. 8. The type of plan requested may include retirement investment plans, such as a 401k, a 403b, a 457, an Automatic IRA, and the like. The employer information may be stored in the database based on a quote management database schema.

The system may provide for an intelligent quote request routing system 32. The intelligent quote request routing system 32 analyzes the company information and routes the request to an appropriate retirement plan service provider 28. The routing system may be based on information received from a participating retirement investment plan representative. The routing system may also be based on information relating to a retirement investment plan gathered by the market host.

In either event, the routing system 33 may route requests for a quote to investment plan representatives 28 that meet the parameters of the requesting employer 26. For example, a given retirement investment plan may have a minimum or maximum number of participating employees as a screening criteria for the plan. Similarly, the retirement investment plan may also have a minimum or maximum asset base as a screening criteria for the plan. Other plans may only be offered for participating employees in certain states or countries.

The retirement plan market place of the present invention also provides a quote portal 34, through which a retirement plan representative 28 may review an appropriately routed quote request. The retirement plan representative 28 may enter a quote for the requested retirement plan or retirement plan services. The quote portal 34 presents the requesting company's information to the retirement plan representative 28 and allows the representative 28 to input quote information responsive to the request. The quote portal 34 may also provide for the upload of documents that may specify quote details and required investment disclosure documents.

At an advisor review portal 35, an advisor 27 may review the quotes submitted by each retirement service provider 28 responsive to the employer's request. After reviewing the quotes, the advisor 27 will approve the quotes. After the advisor 27 has approved the quotes, the system conveys the quotes to the employer 26. In certain embodiments of the marketplace of the present invention, the advisor 27 role may be configured to be performed automatically, responsive to the receipt of a quote request from an employer 26. The marketplace may also be configured such that the advisor 27 role is performed to automatically review and approve quotes received from the retirement plan service provider 28.

Since, the quotes from various providers 28 can be structured differently and the variations among provider quotes make it almost impossible for a human being to determine the actual cost of plan services from various providers 28, a fee analyzer transforms the quotes received to permit a comparison of the actual costs of a plan by the employer 26. As such, the retirement plan market place of the present invention transforms the advisor approved quotes for a comparison presentation to the employer 26 via an employer plan comparison portal 36. The system transforms the quote information to extract and transform the fee structures and revenue sharing arrangements associated with the quote, some of which may otherwise be hidden or obscured to the employer 26, based on the fee structuring methods and the quotation methods utilized by the various retirement plan representatives 28.

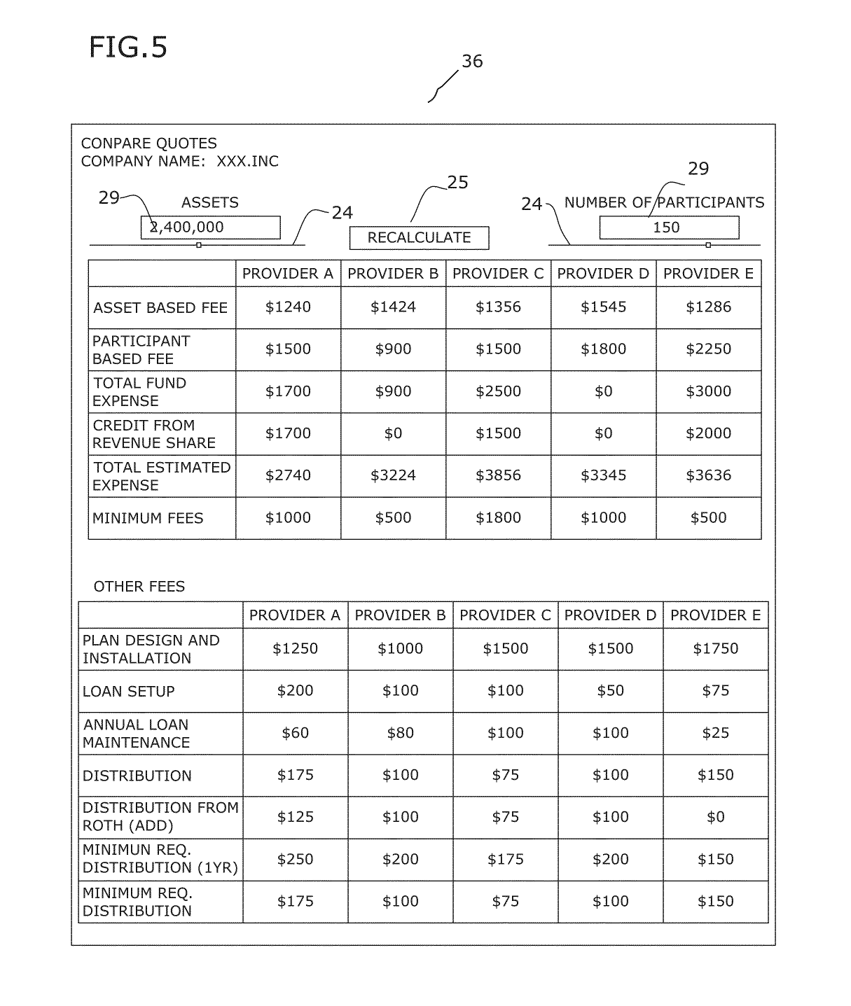

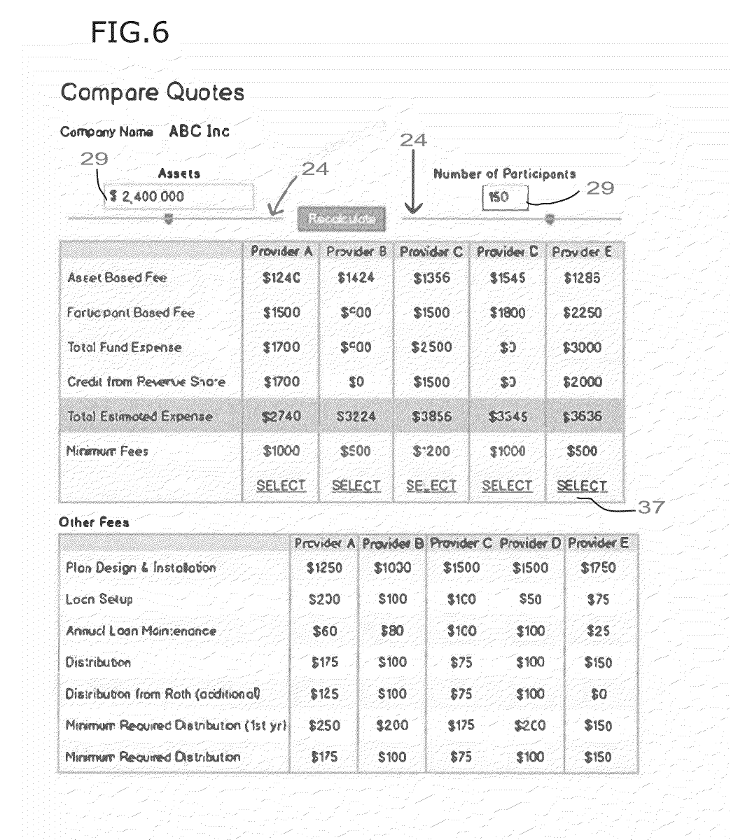

As seen in reference to FIG. 5, using the transformed quote information, an embodiment of the employer plan comparison portal 36 presents the employer 26 with a line by line fee comparison among competing plans, thereby permitting the employer 26 to make an informed comparison between competing retirement services plans. In some embodiments, the system provides controls 24 on the employer plan comparison portal 36 to permit the employer 26 to vary their initial company information and run various fee comparison scenarios across the providers 28 to determine whether the plans will still meet the employer's and their employee's needs, based on a range of input parameters.

By way of example, the controls 24 may include a slider bar that permits the employer 26 to change the projected asset value of their employee's portfolio. The controls 24, 25, 29 may also include a slider bar 24 that permits the employer 26 to adjust the number of participants in the plan. The employer plan comparison portal 36, may also provide the employer 26 the opportunity to input asset or participant values into a respective data field. The employer plan comparison portal 36 may be programmed to recalculate the table dynamically after receiving or detecting an input value change condition. Alternatively, a button 25 may be provided for the employer 26 to recalculate the comparison table after changing the desired parameters. The system then may make a recommendation to the employer but may present all the quotes to the employer. The employer may also be provided a control to access the proposal document uploaded by the record-keeper (provider). After the employer 26 has had an opportunity to compare the competing plans, the system may then present the employer 26 with a plan selection interface 37, as seen in reference to FIG. 8.

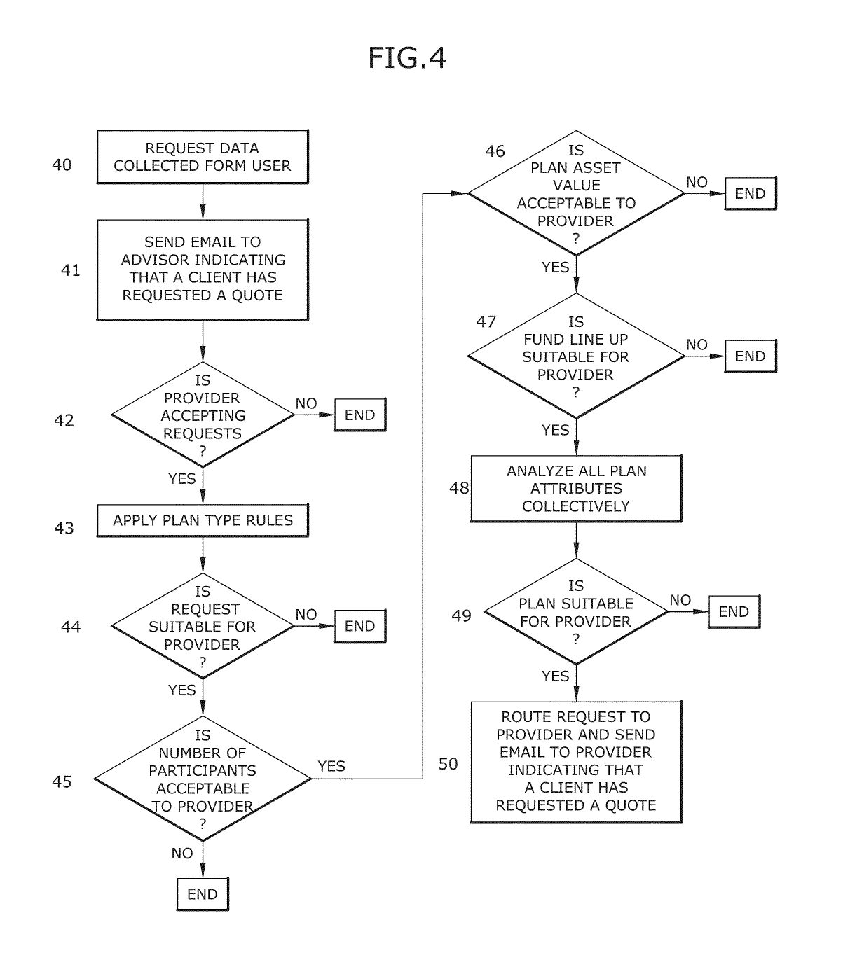

In reference to FIG. 4, a flowchart of an embodiment of a retirement plan provider work flow is illustrated. In the first step, at block 40 the system receives a retirement plan quote request from an employer 26, based on the employer information entered by the employer 26. Responsive to the request 40, at block 41 the system generates an e-mail to an advisor 27 indicating that an employer 26 has requested a quote.

At block 42, the system may determine whether a provider 28 is accepting quotes. If a provider 28 is not accepting quotes, such as when a plan is already full or closed to new participants, the workflow ends. If the provider 28 is accepting quotes, the system applies one or more plan type rules 43 to the quote request for potential routing of the quote request the provider 28.

A first rule 44 may determine whether the requested plan is suitable for the plan provider 28. If the requested plan isn't suitable for the plan provider 28 the process ends. If the requested plan is suitable for the plan provider 28, the system may apply a second rule 45 to determine whether the number of participants in the requested plan is within the plan provider's specified parameters. If the number of participants does not satisfy the plan provider's parameters, the process ends. If the number of participants in the requested plan is suitable for the provider 28, a third rule 46 may be applied.

A third rule 46 may then be applied to determine whether the projected plan asset value is acceptable to the plan provider 28. If the asset value is unacceptable the routing of the request is terminated. If the asset value meets the plan provider's parameters, the routing of the request may apply a fourth rule 47.

In applying the fourth rule 47, the system may determine whether the requested retirement investment fund line is suitable for the fund provider. If the requested fund line is not suitable for the fund provider, the routing of the request is terminated. If the fund lineup is suitable for the provider, the system routes the request to a plan attribute analysis 48.

The plan attribute analysis 48 performs an analysis of all the requested plan attributes collectively. The system analyzes retirement plan provider characteristics and the quote from the provider against company attributes like number of employees, expected plan assets, location, number of payrolls, etc. and determines whether a proposal from the provider is suitable. As quote requests and quotes flow through the system, the system is designed to be self-learning and enhance itself in terms of routing quote requests to the most suitable providers.

After performing a collective analysis of the plan's attributes the system may provide a final determination 49 of whether the requested plan is suitable for the provider. If the plan is not suitable for the provider the routing of the request is terminated. If the final determination 49 is suitable for the provider, at block 50 the system routes the request to the provider 28.

The computer-based system and method for comparing quotes for retirement plan services described above is for purposes of example only, and may be implemented in any type of computer system or programming or processing environment, or in a computer program, alone or in conjunction with hardware. The present invention may also be implemented in software stored on a non-transitory computer-readable storage medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer.

It is further contemplated that the present invention may be run from a server computer system that can be accessed by a plurality of client computer systems interconnected over an intranet network, or that is accessible to clients over the Internet. To the extent the present application discloses a system, the method implemented by that system, as well as software stored on a non-transitory computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method of providing a marketplace for retirement plans, comprising:
automatically at a server of a retirement plan advisor, in response to a request for a quote, activated via a quote request page presented on a first web browser of an employer seeking a retirement plan, determining at least one appropriate retirement plan type corresponding to the request for the quote;
automatically retrieving, from a non-transitory computer storage media coupled to the server, information identifying at least one retirement plan provider offering the at least one appropriate retirement plan type in the marketplace;
automatically at the server, transmitting the request for the quote to the at least one retirement plan provider;
automatically at the server, in response to receiving at least one quote submission, activated via a quote submission page presented on a second web browser of the retirement plan provider, transforming the at least one quote submission to a plan comparison data,
automatically with the server computer generating for the first web browser, a retirement plan comparison page presenting the plan comparison data set for each of the at least one quote submissions to the employer.

2. The method of claim 1, wherein the request for quote comprises a number of participating employees.

3. The method of claim 1, further comprising:
receiving, via the first web browser, an indication that the employer has an existing retirement plan.

4. The method of claim 3, further comprising:
prompting the employer to input information pertaining to the existing retirement plan via the first web browser.

5. The method of claim 4, wherein the information pertaining to the existing retirement plan comprises the plan type.

6. The method of claim 4, wherein the information pertaining to the existing retirement plan includes an asset base.

7. The method of claim 4, wherein the information pertaining to the existing retirement plan includes an identification of an existing retirement plan provider.

8. The method of claim 1, further comprising:
determining whether the retirement plan provider is accepting requests for quotes.

9. The method of claim 1, further comprising:
determining whether the request for quote is suitable for the provider.

10. The method of claim 1, further comprising:
providing a plan selection tool on the first web browser.

11. A non-transitory computer-readable memory adapted for use by a retirement plan advisor in serving web pages offering a marketplace for retirement plans, the non-transitory computer-readable memory used to direct a server of the retirement plan advisor to perform the steps of:
automatically at the server, in response to a request for a quote, activated via a quote request page presented on a first web browser of an employer seeking a retirement plan, determining at least one appropriate retirement plan type corresponding to the request for the quote;
automatically retrieving, from a non-transitory computer storage media coupled to the server, information identifying at least one retirement plan provider offering the at least one appropriate retirement plan type in the marketplace;
automatically at the server, transmitting the request for the quote to the at least one retirement plan provider;
automatically at the server, in response to receiving at least one quote submission, activated via a quote submission page presented on a second web browser of the retirement plan provider, transforming the at least one quote submission to a plan comparison data,
automatically with the server computer generating for the first web browser, a retirement plan comparison page presenting the plan comparison data set for each of the at least one quote submissions to the employer.

12. The computer readable memory of claim 11, wherein the request for quote comprises a number of participating employees.

13. The computer readable memory of claim 11, wherein the computer-readable memory is used to direct the server of the retirement plan provider to perform the further step of:
receiving, via the first web browser, an indication that the employer has an existing retirement plan.

14. The computer readable memory of claim 13, wherein the computer-readable memory is used to direct the server of the retirement plan provider to perform the further step of:
prompting the employer to input information pertaining to the existing retirement plan via the first web browser.

15. The computer readable memory of claim 14, wherein the information pertaining to the existing retirement plan comprises the plan type.

16. The computer readable memory of claim 14, wherein the information pertaining to the existing retirement plan includes an asset base.

17. The computer readable memory of claim 14, wherein the information pertaining to the existing retirement plan includes an identification of an existing retirement plan provider.

18. The computer readable memory of claim 11, wherein the computer-readable memory is used to direct the server of the retirement plan provider to perform the further step of:
determining whether the retirement plan provider is accepting requests for quotes.

19. The computer readable memory of claim 11, wherein the computer-readable memory is used to direct the server of the retirement plan provider to perform the further step of:
determining whether the request for quote is suitable for the provider.

20. A computerized system for a retirement plan advisor serving web pages offering a marketplace for retirement plans, the system comprising:
means, at a server of the retirement plan advisor, in response to a request for a quote, received from a first web activated by an employer seeking a retirement plan, to automatically determine at least one appropriate retirement plan type corresponding to the request for the quote,
server means for automatically retrieving, from a non-transitory computer storage media coupled to the server, information identifying at least one retirement plan provider offering the at least one appropriate retirement plan type in the marketplace;
server means for automatically transmitting the request for the quote to the at least one retirement plan provider;
server means for automatically, in response to receiving at least one quote submission, activated via a quote submission page presented on a second web browser of the retirement plan provider, transforming the at least one quote submission to a plan comparison data,
server means for automatically computer generating for the first web browser, a retirement plan comparison page presenting the plan comparison data set for each of the at least one quote submissions to the employer.
